(19) United States
(12) Patent Application Publication
(10) Pub. No.: US 2013/0038814 A1
(43) Pub. Date: Feb. 14, 2013

(54) True Color Liquid Crystal Displaying Device

(71) Applicants: Wei LIN, Xiamen Torch (CN); Cheng Yu TU, Xiamen Torch (CN); Li Mei LI, Xiamen Torch (CN)

(72) Inventors: Wei LIN, Xiamen Torch (CN); Cheng Yu TU, Xiamen Torch (CN); Li Mei LI, Xiamen Torch (CN)

(21) Appl. No.: 13/563,800

(22) Filed: Aug. 1, 2012

(30) Foreign Application Priority Data
Aug. 12, 2011 (CN) 201120293871.9

(51) Int. Cl. G02F 1/13357

(52) U.S. Cl. 349/62

(57) ABSTRACT

A true color liquid crystal displaying device is disclosed in the present invention. The true color liquid crystal displaying device includes a light guide module, a LED light source, and a liquid crystal panel without a color filter. The light guide module includes a light guide body, an optical input portion and an emitting surface. The emitting surface includes an emitting area. The LED light source is disposed on the optical input portion of the light guide module for emitting RGB beams. The liquid crystal panel is disposed above the emitting surface of the light guide module. The emitting area aligns with a sub-pixel of the liquid crystal panel. The optical cable inside the light guide module guides the monochromatic beam from the LED light source to each corresponding sub-pixel of the liquid crystal panel, so that the RGB beams is the pixel of the true color performance.

### BACKGROUND OF THE INVENTION

1. Field of the Invention

The present invention relates to a passive liquid crystal displaying device, and more particularly, to a true color liquid crystal displaying device.

2. Description of the Prior Art

A conventional planar displaying device, such as a liquid crystal displaying device, often utilizes TFT-LCD technology. The TFT-LCD technology is a passive light display, and a white light backlight module is a light source of the TFT-LCD technology for colorful performance via a color filter of the TFT-LCD liquid crystal panel. The conventional displaying device includes several drawbacks. For example, a white LED of the white light backlight module utilizes a blue LED with yellow phosphor to generate a white beam, and color gamut of the white LED equals 70%. The liquid crystal panel includes the color filter, and a cost of the color filter equals 24 percentage of a cost of the liquid crystal displaying device. Manufacture of the color filter is complicated, and penetration rate of the color filter equals 33%, so utility factor of the light source is decreased.

In addition, the true color LED display is applied to an outdoor advertising, and a large amount of RGB LED is utilized to align with each pixel of the true color LED display for true color performance. Because one LED and one driver are set to correspond to each pixel, the set of the LED and the driver is expensive and can not be applied to a high quality liquid crystal displaying device that includes large numbers of pixels, such as a liquid crystal television or a monitor.

### SUMMARY OF THE INVENTION

The present invention provides a true color liquid crystal displaying device that utilizes RGB LED as a light source for cost economy and true color performance for solving above drawbacks.

According to the claimed invention, a true color liquid crystal displaying device includes a light guide module, a LED light source and a liquid crystal panel. The light guide module includes a light guide body, an optical input portion and an emitting surface. The emitting surface includes an emitting area. The LED light source is disposed on the optical input portion of the light guide module for emitting RGB beams. The liquid crystal panel is disposed above the emitting surface of the light guide module. The emitting area aligns with a sub-pixel of the liquid crystal panel. The beam from the LED light source is transmitted into the light guide module via the optical input portion, and is further transmitted into the liquid crystal panel via the light guide body and the emitting area on the emitting surface. The liquid crystal panel does not comprise a color filter.

According to the claimed invention, the LED light source is embedded in or outwardly disposed on the optical input portion of the light guide module. An external optical cable is disposed between the LED light source and the light guide module when the LED light source is outwardly disposed on the optical input portion of the light guide module.

According to the claimed invention, the LED light source comprises three monochromatic light emitting diodes. The monochromatic light emitting diodes comprise a red light emitting diode, a green light emitting diode and a blue light emitting diode.

According to the claimed invention, the light guide body is an optical cable. Two ends of the optical cable respectively are the optical input portion and the emitting area.

According to the claimed invention, the optical cable comprises a red light cable, a blue light cable and a green light cable, arranged sequence of the red light cable, the blue light cable and the green light cable is identical to arranged sequence of sub-pixels of the liquid crystal panel. Each emitting area aligns with the sub-pixel composed of the red light cable, the blue light cable or the green light cable, which means that the pixel is composed of the RGB light source.

The present invention utilize the optical cable inside the light guide module to guide monochromatic beam from the LED light source into each corresponding sub-pixel of the liquid crystal panel, so that each pixel of the true color performance can be the RGB light. The liquid crystal panel does not include the color filter, so as to decrease manufacturing cost of the product and to increase utility factor of the light source. Color gamut of the RGB LED light source of the present invention can equal 95%.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a structural diagram of the true color liquid crystal displaying device according to an embodiment of the present invention.

FIG. 2 is a structural diagram of the optical cable disposed inside the light guide module according to the embodiment of the present invention.

FIG. 3 is a structural diagram of the embedded LED light source and the light guide module according to the embodiment of the present invention.

### DETAILED DESCRIPTION OF THE INVENTION

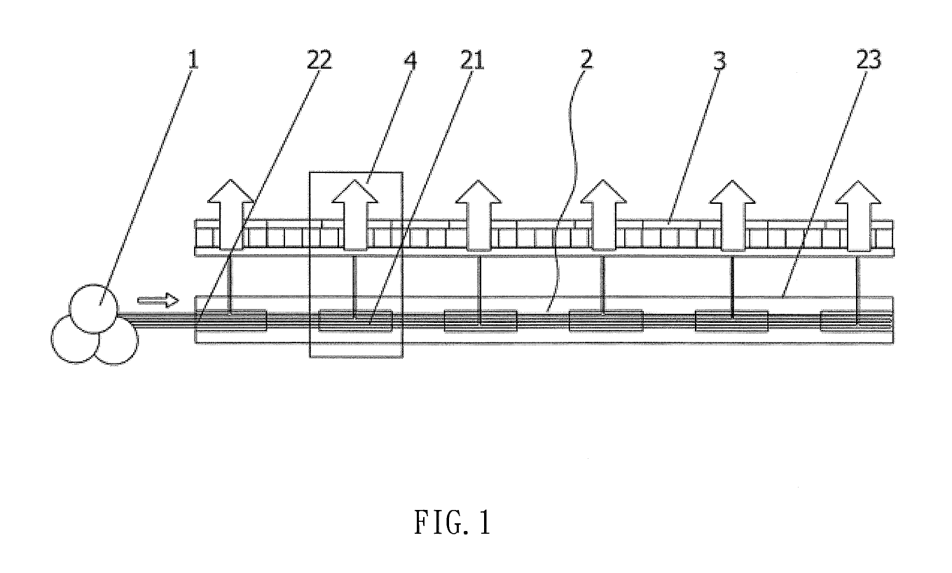

As shown in FIG. 1 to FIG. 3, the present invention includes a light emitting diode (LED) light source 1 for emitting RGB beams, a light guide module 2, and a liquid crystal panel 3 without a color filter. The light guide module 2 includes a light guide body 21, an optical input portion 22 and an emitting surface 23. The LED light source 1 is disposed on the optical input portion 22 of the light guide module 2. The liquid crystal panel 3 is disposed above the emitting surface 23 of the light guide module 2. The emitting surface 23 includes at least one emitting area, and each emitting area can align with each corresponding sub-pixel 4 of the liquid crystal panel 3. The beam emitted from the LED light source 2 can be transmitted into the light guide module 2 via the optical input portion 22, and then be transmitted into the liquid crystal panel 3 via the light guide body 21 and the emitting area on the emitting surface 23.

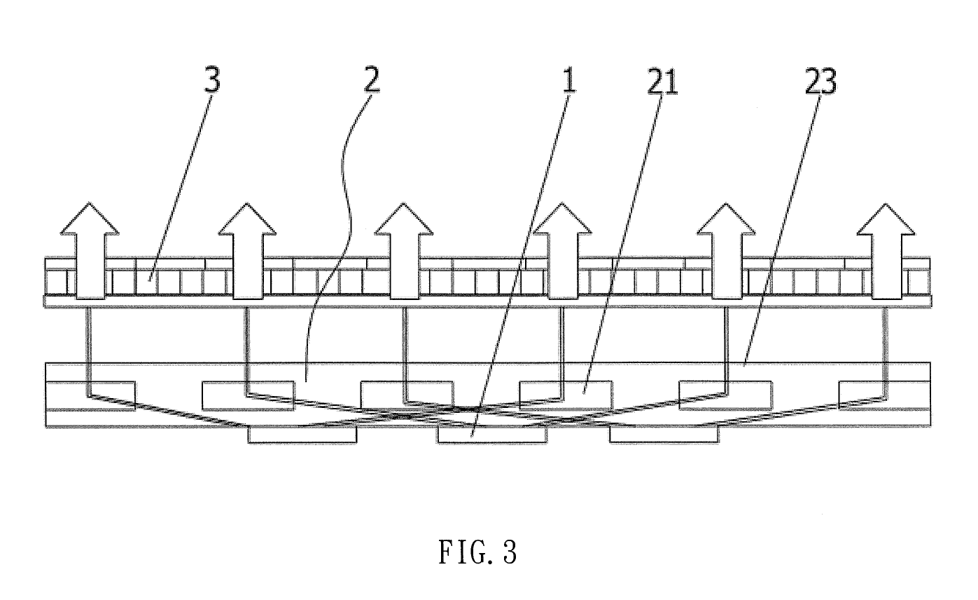

As shown in FIG. 1 or FIG. 3, the LED light source 1 is embedded in or outwardly disposed on the optical input portion 22 of the light guide module 2. When the LED light source 1 is outwardly disposed on the optical input portion 22 of the light guide module 2, an external optical cable is disposed between the LED light source 1 and the light guide module 2. The beam is emitted from the LED light source 1 to the optical input portion 22 of the light guide module 2 via the external optical cable, and is split and guided by an optical cable disposed inside the light guide module 2. Thus, disposition of the LED light source 1 and the light guide module 2 is not limited to the above-mentioned embodiment, and depends on design demand.

The LED light source 1 includes three monochromatic light emitting diodes (LED), and the monochromatic light emitting diodes can be a red LED, a green LED and a blue LED.

The light guide body 21 is an optical cable. An end of the optical cable is the optical input portion 22, and the other end of the optical cable is the emitting surface 23. The light guide body (optical cable) 21 is set in an ordered entwisting manner, so the beam is transmitted from the optical input portion 22 to the emitting surface 23 when entering the light guide body 21.

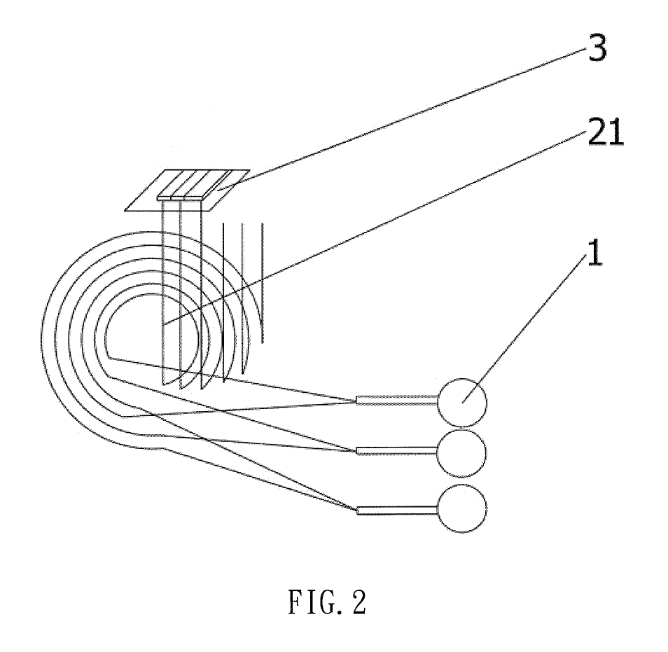

As shown in FIG. 2, the light guide body (optical cable) 21 includes a red light cable, a blue light cable and a green light cable. Arranged sequence of the light guide body 21 (which includes the red light cable, the blue light cable and the green light cable) is identical to arranged sequence of sub-pixels 4 of the liquid crystal panel 3. Each emitting area aligns with the sub-pixel 4 composed of the red light cable, the blue light cable or the green light cable, which means that the pixel is composed of the red light, the blue light and the green light.

In conclusion, the present invention can transmit the beam from the LED light source 1 into the light guide module 2 via the optical input portion 22. Then, the beam can be split and guided by the optical cable inside the light guide module 2, and be transmitted out of the emitting surface 23 of the light guide module 2 via the emitting area. Because each emitting area aligns with each corresponding sub-pixel 4 of the liquid crystal panel 3, the liquid crystal panel 3 can show a true color performance without the color filter.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A true color liquid crystal displaying device comprising:
a light guide module, the light guide module comprising a light guide body, an optical input portion and an emitting surface, the emitting surface comprising an emitting area;
a light emitting diode (LED) light source disposed on the optical input portion of the light guide module for emitting RGB beams; and
a liquid crystal panel disposed above the emitting surface of the light guide module, the emitting area aligning with a sub-pixel of the liquid crystal panel, the beam from the LED light source being transmitted into the light guide module via the optical input portion, and being further transmitted into the liquid crystal panel via the light guide body and the emitting area on the emitting surface;
wherein the liquid crystal panel does not comprise a color filter.

2. The true color liquid crystal displaying device of claim 1, wherein the LED light source is embedded in or outwardly disposed on the optical input portion of the light guide module, an external optical cable is disposed between the LED light source and the light guide module when the LED light source is outwardly disposed on the optical input portion of the light guide module.

3. The true color liquid crystal displaying device of claim 1, wherein the LED light source comprises three monochromatic light emitting diodes, the monochromatic light emitting diodes comprise a red light emitting diode, a green light emitting diode and a blue light emitting diode.

4. The true color liquid crystal displaying device of claim 1, wherein the light guide body is an optical cable, two ends of the optical cable respectively are the optical input portion and the emitting area.

5. The true color liquid crystal displaying device of claim 4, wherein the optical cable comprises a red light cable, a blue light cable and a green light cable, arranged sequence of the red light cable, the blue light cable and the green light cable is identical to arranged sequence of sub-pixels of the liquid crystal panel.
